(19) United States
(12) Patent Application Publication
(10) Pub. No.: US 2018/0314798 A1
(43) Pub. Date: Nov. 1, 2018

(54) DIRECTING MEDICAL PATIENTS TO AN APPROPRIATE LEVEL OF CARE AND TO APPROPRIATE HEALTHCARE RESOURCES

(71) Applicants: CALEB SANTIAGO HERNANDEZ, DENVER, CO (US); MICHAEL STEPHEN HILL, THORNTON, CO (US)

(72) Inventors: CALEB SANTIAGO HERNANDEZ, DENVER, CO (US); MICHAEL STEPHEN HILL, THORNTON, CO (US)

(21) Appl. No.: 15/393,738

(22) Filed: Dec. 29, 2016

(51) Int. Cl. G06F 19/00

(52) U.S. Cl. CPC G06F 19/322; G06F 19/3406; G06F 19/3431

(57) ABSTRACT

A system and a method for directing medical patients to an appropriate level of care and processes for directing a medical patient to an appropriate healthcare resource are disclosed. The system, the method, and the processes allow non-physicians to navigate the healthcare system, prevent missed emergencies, and direct patients to appropriate healthcare resources, thereby making healthcare more affordable, accessible, and efficient.

### BACKGROUND

Embodiments of the invention described in this specification relate generally to medical care systems, and more particularly, to a system and a method for monitoring medical health of a patient, determining an appropriate level of care for the patient, and directing the patient to an appropriate medical facility for care.

Illness is common among people. While some people consistently maintain a high degree of health, many other people get sick unexpectedly with varying degrees of illness. Many of these sick people (hereinafter referred to as “patients”) are not identified and treated early enough to prevent or minimize the effects of illness. As a result of mistriage and/or medical errors, many of the sicker patients suffer harm that could have been prevented or limited with proper decision-making and directing of patients to appropriate healthcare resources.

In conventional healthcare systems (e.g., healthcare systems of hospitals, clinics, etc.), many medical complaints require a physician or other medical professional to tell the difference between an emergency or sub-acute medical problem. For example, a sore throat can present as strep throat, but a deadly abscess of the throat can also cause sore throat. However, medical resources are limited and healthcare systems typically try to adapt to the gap in medical resources. Under this scenario, conventional healthcare systems bear the burden of early mistriage, including medical errors, potential harm, and increased costs to the system. Annually, the United States spends more than double other countries' outlays on medical healthcare, yet the results are average at best. For example, the United States spent approximately three trillion dollars ($3,000,000,000,000) on healthcare in 2015, of which 40% ($1.2 trillion) has been widely considered wasteful spending.

While conventional healthcare systems help some patients to limit harm from illness, most healthcare systems have limited resources. Therefore, healthcare systems seek to balance patient acuity level with capabilities. However, finding the right balance is a challenge for many healthcare systems. When patient acuity level is not balanced with capabilities, resources are not used appropriately/efficiently, and this may result in resources being unavailable for others who need them as well.

Logistical challenges also exist for most conventional healthcare systems. Logistics are especially difficult for conventional healthcare systems in terms of the patient area, in particular, when the patient area is a rural or remote region.

Other systems exist for ascertaining acuity of a patient. However, success in the existing systems typically depends on a number of varying factors. For example, existing systems generally lack consistency because they have a large subjective component due to operator variability.

Thus, the conventional healthcare systems and other existing systems are simply not capable of incorporating all patient variables (e.g., complaint, vitals, risk factors, medical history, etc.) and efficiently balancing the allocation of available resources in an effort to identify efficient and appropriate medical care for an ill patient, thereby hindering (or preventing) efforts to control or reduce costs while ensuring that patients who are more ill than initially perceived are not mistreated or neglected.

Therefore, what is needed is a way to improve decision-making in the type of facility necessary to handle a patient's acute illness, catch illnesses before they become acute, reduce medical professional variability in determining an optimum treatment environment for the patient, manage new, existing, and chronic medical problems, track vital signs data and send alerts if a patient's vital signs worsen beyond a threshold amount, and connect the patient with an appropriate healthcare resource (e.g., ambulance, clinic, urgent care, emergency care, hospital, etc.) in a way that reduces operator/environment variability in the process of balancing a multitude of factors (e.g., vital signs, medical history, medical complaints, age, risk factors, availability of resources, etc.) in view of the present location of the patient (e.g., in a hospital, in a city, or in a geographical region), and to increase access to medical care for ill patients, make medical care more convenient, and lower the cost of medical care in a way that allows even non-medical professionals to match resources to patients in any environment.

### BRIEF DESCRIPTION

Some embodiments of the invention include a novel decision making medical system and a novel method for monitoring medical health of a patient, determining an appropriate level of healthcare for the patient, and directing the patient to an appropriate medical facility which can provide the necessary healthcare to the patient.

In some embodiments, the decision making medical system and the method for directing medical patients to an appropriate level of healthcare determines patient acuity and patient medical needs to be addressed, determines available healthcare system resource capabilities, and then assigns a capable healthcare system resource to the patient. In some embodiments, the decision making medical system and the method for directing medical patients to an appropriate level of healthcare assigns a capable healthcare system resource by matching patient acuity to available healthcare system resource capabilities once both values are known.

In some embodiments, the decision making medical system and the method for directing medical patients to an appropriate level of healthcare standardizes and streamlines navigation through the healthcare system and decision making in relation to patient medical needs and available medical resources. In some embodiments, the decision making medical system streamlines navigation and decision making by way of an interface that allows non-physicians to (i) manage new, existing, and chronic medical problems, (ii) track vital signs data and send alerts if a patient's vital signs worsen beyond a threshold amount, and (iii) send a notification to and connect the patient with the appropriate resource in the healthcare system, depending on the severity of the condition as determined by a combination of the patient's health status (patient profile), the current medical condition of the patient (including vitals), and the geographic location of the patient and available resources. Thus, non-physicians will be able to use the decision making medical system to navigate the healthcare system, prevent missed emergencies, and make accessing healthcare more affordable and accessible as well as efficient.

In some embodiments, the method for directing medical patients to an appropriate level of healthcare includes interviewing a patient to collect patient information about a medical condition of the patient, evaluating vital signs of the patient, determining an acuity level for the patient based on the patient information and the vital signs of the patient, matching the patient's acuity level to available medical resources that are capable of treating the condition of the patient, and assigning the available medical resources to the patient for treatment of the condition of the patient.

In some embodiments, the decision making medical system includes one or more medical data information systems and associated medical databases, medical computing devices, and software applications that provide access to the medical data information systems and associated medical databases and that visually output an interface for patient information on a computer monitor of a computing device used by an untrained user (such as a patient or a representative of a patient) or trained operator (such as non-physician healthcare personnel) or on a mobile device screen of a mobile device used by a medically untrained user (e.g., patient, patient representative, etc.) or a trained medical professional (such as a physician or a non-physician medical worker) in a remote location, a field location, or a mobile location. In some embodiments, the medical database associated with the medical data information systems stores medical resource information that identifies medical resources, locations of the medical resources, and availability of the medical resources. In some embodiments, the medical resources include at least an ambulance, a specialized emergency vehicle, a clinic, a hospital, an emergency room (ER), an urgent care center, and an insurance company. In some embodiments, the medical resource information includes assigned capability scores associated with a level of healthcare that a healthcare resource is capable of providing. In some embodiments, the medical resource information includes identities of medical professionals and weighted scores associated with a level of healthcare that a medical professional is capable of providing. In some embodiments, the medical resource information includes status qualifiers. The status qualifiers include a primary resource qualifier, a secondary resource qualifier, and a tertiary resource qualifier.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a method of some embodiments for monitoring medical health of a patient, determining an appropriate level of healthcare for the patient, and directing the patient to an appropriate medical facility.

FIG. 2 conceptually illustrates a continuation of the method for monitoring medical health of a patient, determining an appropriate level of healthcare for the patient, and directing the patient to an appropriate medical facility shown in FIG. 1.

FIG. 3 conceptually illustrates a schematic view of a decision making medical system that directs medical patients to appropriate levels of healthcare in some embodiments.

FIG. 4 conceptually illustrates a process for directing a medical patient to an appropriate healthcare resource in some embodiments.

FIG. 5 conceptually illustrates a patient interview process in some embodiments.

FIG. 6 conceptually illustrates a process for obtaining physiologic data of a patient in some embodiments.

FIG. 7 conceptually illustrates a process for calculating patient acuity in some embodiments.

FIG. 8 conceptually illustrates a process for matching and recommending healthcare resources for a patient in some embodiments.

FIG. 9 conceptually illustrates a process for generating and securely transferring a personalized standardized report regarding the patient to a healthcare resource in some embodiments.

FIG. 10 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

### I. Directing Medical Patients to an Appropriate Level of Healthcare

Some embodiments of the invention include a novel decision making medical system and a novel method for monitoring medical health of a patient, determining an appropriate level of healthcare for the patient, and directing the patient to an appropriate medical facility which can provide the healthcare to the patient.

In some embodiments, the decision making medical system and the method for directing medical patients to an appropriate level of healthcare determines patient acuity and patient medical needs to be addressed, determines available healthcare system resource capabilities, and then assigns a capable healthcare system resource to the patient. In some embodiments, patient acuity is measured or determined before healthcare system resource capability. In some embodiments, healthcare system resource capability is measured or determined before patient acuity. In some embodiments, the decision making medical system and the method for directing medical patients to an appropriate level of healthcare assigns a capable healthcare system resource by matching patient acuity to available healthcare system resource capabilities once both values are known.

In some embodiments, the decision making medical system and the method for directing medical patients to an appropriate level of healthcare standardizes and streamlines navigation through the healthcare system and decision making in relation to patient medical needs and available medical resources. In some embodiments, the decision making medical system streamlines navigation and decision making by way of an interface that allows non-physicians to (i) manage new, existing, and chronic medical problems, (ii) track vital signs data and send alerts if a patient's vital signs worsen beyond a threshold amount, and (iii) send a notification to and connect the patient with the appropriate resource in the healthcare system, depending on the severity of the condition as determined by a combination of the patient's health status (patient profile), the current medical condition of the patient (including vitals), and the geographic location of the patient and available resources. Thus, non-physicians will be able to use the decision making medical system to navigate the healthcare system, prevent missed emergencies, and make accessing healthcare more affordable and accessible as well as efficient. In this way, untrained users (such as patients) or trained operators (such as non-physician healthcare personnel) are less likely to enter false information, and many of the important criteria that are necessary to assign a patient acuity level are not ignored or omitted, resulting in greater accuracy in allocating healthcare resources for the care of unwell patients and allowing for more efficient direction of patient care, thereby cutting costs.

As stated above, many patients tend to get sick unexpectedly with varying degrees of illness. While conventional healthcare systems and other existing systems are in place to treat sick patients, conventional healthcare systems and other existing systems are often not able to incorporate all patient variables (e.g., complaint, vitals, risk factors, medical history, etc.) and, therefore, cannot efficiently balance the allocation of available resources in an effort to identify efficient and appropriate medical care for an ill patient. In addition, many medical complaints require a physician or other medical professional to tell the difference between an emergency or sub-acute medical problem. For example, a sore throat can present as strep throat, but a deadly abscess of the throat can also cause sore throat. However, conventional healthcare systems and other existing systems are often not able to balance patient acuity levels with available healthcare resources. This is due, at least in part, to healthcare resource limitations, logistical challenges, and a great amount of subjective input. For example, to ensure accurate patient evaluation and acuity level, a variety of important criteria needs to be correctly processed. Yet, many of the important criteria that are necessary to assign a patient acuity level are often ignored or omitted. In the conventional healthcare systems, therefore, sicker patients are routinely not identified properly and/or not treated early enough or sufficiently enough to limit harm from their illnesses. Thus, the existing systems in conventional healthcare often hinder or prevent (rather than help) efforts to control or reduce costs in the effort to put the right healthcare resources in place to treat patients who are more ill than initially perceived and avoid mistreatment or neglect of the patient.

Moreover, non-physician healthcare personnel and patients in conventional healthcare systems often fail to appreciate the acuity of illnesses in regard to particular patients with particular medical patient profiles. When a decision needs to be made as to medical resources (e.g., the type of facility necessary to handle the patient's particular acute illness given the patient's medical profile), conventional healthcare systems typically miss the mark for many patients, thereby increasing the potential for harm to patients, exposing the healthcare system to inefficiencies that impact the availability of medical resources for other patients, and compounding the costs of providing healthcare to patients. Additionally, non-physician healthcare personnel and patients in conventional healthcare systems often fail to catch illnesses before they become acute. The conventional healthcare systems also have not reduced medical professional variability in determining the optimum treatment environment for the patient.

Embodiments of the method for directing medical patients to an appropriate level of care described in this specification solve such problems by a patient sorting process and a decision making process for determining and assigning an acuity level to the patient without a physician, thereby improving efficiency of healthcare delivery and accuracy in identifying patients' risks and matching them to the level of care necessary to treat the level of the patients' illnesses. In some embodiments, the patient sorting process provides a standardized approach that greatly reduces variability and streamlines the process of putting appropriate healthcare resources in place to treat patients according to accurate patient illness evaluation. Standardizing and streamlining the process allows for more accurate patient to healthcare resource assignments. This also allows for more efficient direction of patient care, thereby fostering an ability to reduce costs (e.g., a patient is not directed to the ER when the patient can be effectively treated in urgent care). In this way, the method for directing medical patients to an appropriate level of care enables non-physicians or even non-medical experts to sort patients when a physician may not be available or practical. This can increase access of care and convenience.

The method for directing medical patients to an appropriate level of care of the present disclosure may be comprised of the following elements. This list of possible constituent elements is intended to be exemplary only and it is not intended that this list be used to limit the method for directing medical patients to an appropriate level of care of the present application to just these elements. Persons having ordinary skill in the art relevant to the present disclosure may understand there to be equivalent elements that may be substituted within the present disclosure without changing the essential function or operation of the method for directing medical patients to an appropriate level of care.

1. Healthcare system/geographic location with various capabilities (e.g., ambulance, clinic, emergency, hospital, insurance company).

2. Healthcare system resources are assigned a value or are weighted depending on capability (e.g., level 1 resource gets a high score, level 2 gets a lower score, etc.).

3. Various entities within that system are also weighted.

4. Facilities/resources are assigned primary, secondary, tertiary capabilities and so forth to ensure resources are available.

5. Patients are interviewed and patient specific information is elicited.

6. Patient specific information includes, but is not limited to name, age, chief complaint and vital signs.

7. Patient information is analyzed and an acuity level is assigned.

8. Patient acuity is matched with the available healthcare system resources.

9. Patient is assigned resources with the best match for capability; if the closest resource is already in use (presently being used or currently assigned or allocated), the next best match is picked from the available system capabilities (e.g., patient directed to urgent care instead of hospital emergency room because the wait time is very long).

In some embodiments, directing medical patients to an appropriate level of care distinguishes between acute medical issues and chronic medical conditions. In some embodiments, directing medical patients to an appropriate level of care involves identifying one or more healthcare resources that are available to treat an acute medical issue of a patient and are suitable to treat the acute medical issue of a determined patient acuity.

In some embodiments, the process for directing a medical patient to an appropriate healthcare resource includes initially determining whether a patient needs acute medical attention and care or needs medical attention and care in relation to management of a chronic medical condition. When the patient needs medical attention and care in relation to management of a chronic medical condition, the process for directing a medical patient to an appropriate healthcare resource includes updating the health profile of the patient, setting a physician driven notification, obtaining physiologic data of the patient, and determining whether there is any concerning physiologic data that may need immediate or follow-up medical attention and care.

When the process for directing a medical patient to an appropriate healthcare resource determines that there is no concerning physiologic data, then the process for directing a medical patient to an appropriate healthcare resource presets an interval for sending data and sends a personalized standardized report to a healthcare resource. Alternatively, when the process for directing a medical patient to an appropriate healthcare resource determines that there is concerning physiologic data that may need immediate or follow-up medical attention and care, the process transitions to several steps for gathering additional patient information and determining patient acuity in relation to the concerning physiologic data (or any other medical issue derived while gathering additional patient information). The several steps for gathering additional patient information and determining patient acuity are described below in relation to when the process for directing a medical patient to an appropriate healthcare resource determines that the patient needs acute medical attention.

Concerning the determination of whether the patient is in need of acute care or management of a chronic condition, when the process for directing a medical patient to an appropriate healthcare resource determines that the patient needs acute medical attention and care, then the process includes steps for performing a patient interview, obtaining physiologic data, calculating patient acuity, matching a healthcare resource in view of the patient's medical issue and severity of the medical issue, communicating with the healthcare resource about the patient, and sending a personalized, standardized report to the healthcare resource. After sending the personalized, standardized report to the healthcare resource, the process for directing a medical patient to an appropriate healthcare resource ends.

The method for directing medical patients to an appropriate level of care and the process for directing a medical patient to an appropriate healthcare resource of the present disclosure generally work by following the above-listed steps of the respective method or process. By performing steps of the method for directing medical patients to an appropriate level of care or steps of the process for directing a medical patient to an appropriate healthcare resource, a patient's acuity can be quickly and accurately determined and the patient can be directed to an appropriate level of care or an appropriate healthcare resource.

In this specification, there are several descriptions of methods and processes that are implemented as software applications and run on computing devices to perform the steps of the methods and/or processes. However, it should be noted that for the purposes of the embodiments described in this specification, the word “method” is used interchangeably with the word “process”. Methods or processes for directing medical patients to an appropriate level of care or an appropriate healthcare resource are described, therefore, by reference to several example methods and processes that conceptually illustrate process steps for directing medical patients to an appropriate level of care and identifying medical resources to deploy in the care of medical patients according to acuity levels of the patients.

While Section I, above, conceptually describes directing medical patients to appropriate levels of healthcare, several more detailed embodiments are described in the sections below. Section II conceptually describes a method for directing medical patients to appropriate levels of healthcare. Section III provides an example of a decision making medical system that directs medical patients to appropriate levels of healthcare. Section IV describes a process for directing a medical patient to an appropriate healthcare resource and further describes several processes that may be performed in relation to the process for directing a medical patient to an appropriate healthcare resource. Section V describes an electronic system that implements the method for directing medical patient to an appropriate level of care and the process for directing a medical patient to an appropriate healthcare resource.

### II. Method for Directing Medical Patients to an Appropriate Level of Care

In some embodiments, the method for directing medical patients to an appropriate level of healthcare includes interviewing a patient to collect patient information about a medical condition of the patient, evaluating vital signs of the patient, determining an acuity level for the patient based on the patient information and the vital signs of the patient, matching the patient's acuity level to available medical resources that are capable of treating the condition of the patient, and assigning the available medical resources to the patient for treatment of the condition of the patient. Interviewing a patient can be done in any of several ways, including, without limitation, person to person interviews, a series of questions delivered to a patient in hard-copy paper format or electronically by way of a computing device, such as a desktop or laptop computer, a mobile computing device (e.g., smartphone, tablet, etc.), a wearable computing device, etc. Thus, a patient can self-interview by, for example, completing a patient interview form with the series of questions, either electronically (e.g., smartphone, etc.) or by filling out a hard-copy paper version of the interview form.

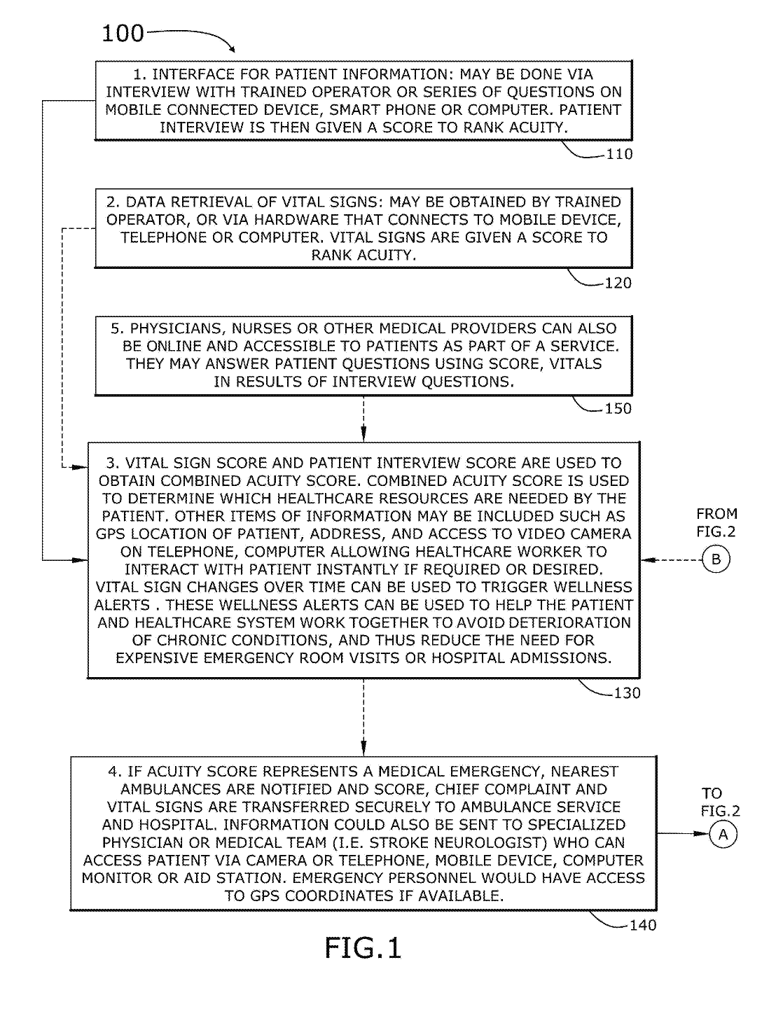

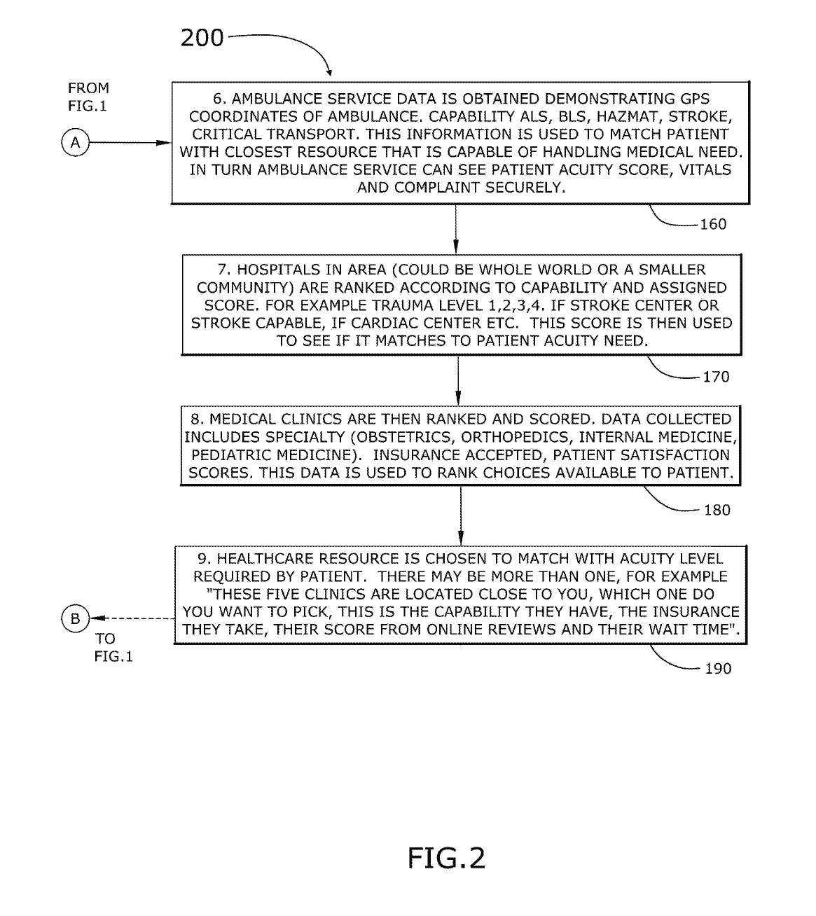

By way of example, FIG. 1 conceptually illustrates a method 100 for directing medical patients to an appropriate level of care, and FIG. 2 conceptually illustrates a continuation 200 of the method for directing medical patients to an appropriate level of care. Taken together, the method 100 and the continuation method 200 include a plurality of steps by which a non-physician can accurately identify an acuity level of a medical patient and direct the medical patient to at least one healthcare resource that is able to provide a level of care that is appropriate for the identified acuity level of the medical patient.

Referring to FIG. 1, the steps of the method 100 include obtaining and scoring patient information (at 110), retrieving and scoring vital signs of the patient (at 120), identifying an acuity level (at 130) of the patient based on the patient information score and the vital signs score to determine which healthcare resources are needed by the patient given the acuity level, and determining whether the acuity level represents a medical emergency (at 140). Also, the method 100 of some embodiments allows for physicians, nurses, or other medical providers to be part of the service by answering patient questions using scores and vital signs observed in relation to the patient (at 150). For example, a physician may see the patient (e.g., a patient with a history of hypertension and present chest pain) and determine that the chest pain is pleuritis, due to inflammation of the rib cage lining. In such instance, a counterweight may be applied so that the acuity level does not suggest a medical emergency or an urgent medical need.

Now referring to FIG. 2, the method 200 includes several steps that are performed when the patient's acuity level is determined to represent a medical emergency (at 140 of method 100). The steps of method 200 include obtaining ambulance service data (at 160), such as location of ambulance, capability of ambulance service, type of ambulance service, etc., scoring and ranking nearby hospitals according to medical capabilities (at 170), scoring and ranking nearby medical clinics (at 180) according to medical specialties, acceptability of insurance, patient satisfaction scores, etc., and choosing healthcare resources that are suitable for a medical emergency and that satisfy the patient's acuity level (at 190). In some embodiments, the patient may need follow-up medical service/assistance after the medical emergency is appropriately handled. Thus, the method 200 of some embodiments transitions back to method 100 to determine (at 140) further healthcare resources and service needed by the patient following the medical emergency. In some embodiments, the patient's acuity level is reviewed and identified again after the medical emergency, so that the medical patient can be directed to an appropriate level of care for the follow-up medical service.

While these steps summarize how the methods 100 and 200 direct medical patients to an appropriate level of care, each of the steps 110, 120, 130, 140, 150, 160, 170, 180, and 190 are described in greater detail below.

Patient condition/acuity is measured at patient intake. Patients are interviewed in relation to a series of standardized questions. Patient interviews can be self-directed patient-completed interviews in which the patient answers each of a series of questions either electronically (e.g., on a smartphone or tablet) or on a hard-copy paper interview form. Each question is weighted and the patient is given a final score. In obtaining patient information and vital signs data, a variety of mechanisms can be used. For example, the patient can be interviewed by a non-physician medical worker, a physician, or by a personal representative of the patient (e.g., a care taker). Alternatively, the patient may self-interview, either by completing the automated interview electronically or in hard-copy paper format, and leave some information for a medical worker to complete (e.g., vital signs measurements, etc.).

In some embodiments, the patient information score is used to rank acuity of the patient's health condition. In some embodiments, the patient information score is weighted based on a medical history of the patient. For example, the patient information score of a patient with a history of hypertension may be weighted by a multiplier (e.g., 1.1, 1.5, or some other multiplier that is determined by the algorithm based on information in the patient's medical profile, information from the patient's physician, or some other source) to emphasize health conditions related to the patient's heart (e.g., the patient's current medical condition, as determined in the patient interview, includes thoracic pain and tightness). Acuity level is then identified. For example, the patient's condition may be determined to be urgent, given the patient's history of hypertension. On the other hand, the patient's present medical condition may not be an urgent medical issue, even though physical manifestations (pain and tightness of the chest) of the underlying condition would concern the patient or another lay person that the patient may be having a heart attack or some other urgent medical problem. Thus, in some embodiments, the identification of acuity level may apply additional weights or counterweights for the present medical condition of the patient. For example, the patient may have a history of hypertension, but along with present thoracic pain and tightness, the patient interview may also divulge enough information to indicate heartburn from elevated stomach acid. Furthermore, physicians, nurses, or other medical providers may provide important information that alters or modifies the patient information score to temper acuity accordingly. For example, a physician may see the patient (e.g., the patient with a history of hypertension and present chest pain) and determine that the chest pain is pleuritis, due to inflammation of the rib cage lining. In such instance, a counterweight may be applied so that the acuity level does not suggest a medical emergency or an urgent medical need.

Thus, the method 100 for directing medical patients to an appropriate level of care described by reference to FIG. 1 starts by obtaining information from the medical patient (at 110). In some embodiments, the method 100 is implemented as a software application that runs on a computing device to display a graphical user interface (GUI) with a plurality of interactive GUI tools including an interface for patient information through which an untrained user (e.g., the patient, a representative of the patient, etc.) or a trained operator (e.g., a non-physician, a physician, a medical professional, or another medical agent) can provide the patient information. The interface for patient information may provide a pop-up window, a side bar sectional display area, a full screen rendered interface, or any other kind of interface that allows an untrained user or a trained operator to interact with the software application in relation to the patient information being obtained.

The interface for patient information may be deployed at a medical call center and may run on a computing device at the medical call center. Examples of a computing device include a desktop computer, a terminal computer, a self-service kiosk, etc. The interface for patient information may alternatively be deployed and run on another computing device or a mobile computing device. Examples of a mobile computing device (hereinafter interchangeably referred to as a “mobile computing device”, a “mobile device”, a “mobile communication device”, or a “mobile computing/communication device”) include a smartphone, a tablet computing device, a custom mobile medical computing device, or another electronic system or mobile device whereby an untrained user or a trained operator can input patient information and/or vital signs data to be used in determining an acuity level for the patient. In some embodiments, the computing device or the mobile device is connected to a network.

In some cases, the patient information is first obtained by a trained operator conducting an interview (either face-to-face or via phone) with the patient and then entering the information about the patient obtained from the interview. In some other cases, a physician or another medical professional communicates directly with the patient and relays the patient information to the trained operator to input into the interface for patient information. In yet other cases, the patient information is entered electronically by the patient or a representative of the patient. As the patient and/or the patient's representative are likely to be non-medical lay persons, the series of questions for the interview may provide a limited number of selectable responses for each question. For example, the patient may use a smartphone to complete the interview, which visually outputs each interview question one after another, along with the limited acceptable responses for each question in the series of interview questions until the interview is complete and the entered information is transmitted to a healthcare facility computing device for evaluation and consideration of healthcare resources that may need to be allocated for the patient. In some embodiments, the interview is presented electronically to a patient while the patient and a healthcare facility agent are on the phone and/or engaged in an electronic computer chat session. Also, the patient or patient's representative may complete the series of interview questions by filling out a hard-copy paper form with responses to the questions. The paper form may then be provided to a worker to input into an electronic version of the interview (e.g., using a computer).

In some embodiments, the interface for patient information automatically displays the series of questions on a computing device or a mobile computing device for an untrained user (e.g., the patient or patient's representative) or a trained operator to complete. For example, a patient may feel sick and use a computing device to connect to the automated interview, entering answers to the series of questions that automatically are displayed for the interview; in another example, a non-physician medical agent at a medical call center may receive a call from a patient with an illness, such as a sore throat, and in response to the call, may launch the automated electronic interview and state each interview question to the patient and input the patient's responses to automatically move through all of the questions of the interview. As the series of questions are displayed, the computing device or the mobile device may receive touch input or touch gesture input on a touch-sensitive device screen to make selections that indicate specific responses to the questions. In some embodiments, the computing device or the mobile device receives audible input, thereby allowing the patient information to be input by a human speaker in response to the series of questions. In some embodiments, the automated interview pauses after each question until a response to the question is provided, and then automatically advances to the next questions (or ends when there are no more questions).

To demonstrate a mobile device example with a trained operator, an emergency medical technician (EMT) may accompany a team of fire fighters to a building fire and may use a mobile computing device to obtain patient information and vital signs data from several patients with a variety of ailments resulting from the fire (e.g., smoke inhalation, flesh burns, flesh wounds from debris, etc.). While the building fire may be considered an emergency and some of the patients afflicted by the fire may need emergency medical aid, not all of the patients would need to have ER treatment. In fact, some of the patients may only need to follow-up with a family physician at a later time. Still other patients may need specialized medical treatment that requires additional medical resources; for example, a burn victim who needs to be airlifted (via medical helicopter) to a hospital that has physicians and medical capabilities suitable for treating extreme flesh burns of patients in critical condition.

To demonstrate a computing device example with an untrained user, a patient (or patient's caretaker) may be an elderly person with a known medical history of bone density loss. The patient may have fallen down and, upon recovering, uses the computing device to obtain medical assistance. During a first step, the automatic patient interview may launch, moving the patient through the series of questions automatically, while contemporaneously retrieving a medical history profile for the patient. Upon receiving all of the responses to the interview questions, the acuity level of the patient may be considered urgent, given the history of bone density loss the patient has endured. Although the patient's responses to the automatic interview questions would have typically been viewed as not urgent (for someone with no history of bone density loss), the method 100 for directing medical patients to an appropriate level of care is able to discern the urgency for this particular patient, given the relationship between the interview question responses and the patient's own medical history. In this way, patients are directed to healthcare resources that are appropriate specifically for their particular medical conditions.

Returning to the method 100 for directing medical patients to an appropriate level of care, after the automated interview is completed, the responses are evaluated and acuity is identified from the patient interview based on the received input. In some embodiments, the method 100 then ranks patient acuity based on the acuity level.

In addition to the patient information, vital signs of the patient are evaluated and the vital sign data is then provided for scoring and ranking of patient acuity. In some embodiments, an untrained user or a trained operator is a patient, a non-medical representative of the patient, or a non-physician medical agent who evaluates the vital signs of the patient and inputs the vital sign data (at 120). In some embodiments, a physician evaluates the vital signs of the patient and relays the information to the trained operator for input of the vital sign data (at 150). The vital signs data, when entered in the computing device, the mobile device, or another electronic system or device, is then used to identify acuity level (based only on the vital signs data) and rank it accordingly.

In some embodiments, after both the patient information and patient vital sign data are obtained and the acuity levels are determined for each, the method 100 then combines the acuity levels to determine an overall or combined patient acuity level (at 130). The combined patient acuity level is then used to determine which healthcare resources are needed by the patient. In some embodiments, a decision making algorithm is implemented as a decision making software module that runs on a computing device or a mobile computing device to determine which medical resources are needed, which medical resources are available, and which medical resources can be deployed to care for the patient. In some cases, several medical resource options are presented from which the trained operator can select based on a variety of factors, such as the location of the patient (e.g., as determined by GPS), address, and/or access to video camera (e.g., on mobile device).

In some cases, patient acuity may change naturally as the patient's health improves or deteriorates over time. In some embodiments, a wellness alert trigger may be implemented within the software application to advise of the patient's improving and/or deteriorating health. For example, a heart rate sensor may detect that a patient's heart rate has increased to a worrisome level. This may then trigger an alert that the patient's heart rate is increasing beyond a threshold level for a specified duration, e.g., more than 1 minute at the elevated heart rate. This and other monitored health aspects may trigger a recalculation of the patient acuity level, thereby ensuring that the patient is directed to the appropriate resources at the right medical facility.

In some embodiments, when the patient is directed to a medical resource or medical resources that can provide an appropriate level of care, given the acuity level of the patient, then the method 100 ends. However, there are a number of medical patients who may have acuity levels representing medical emergencies. Thus, when the patient's combined acuity level represents a medical emergency as determined in the method 100 (at 140), nearby ambulances and/or emergency medical transportation vehicles are identified. Based on the location of the patient, the nearest such ambulance or medical transportation vehicle is then notified of the need for emergency transportation to a hospital or specific medical treatment center. For example, a specialized physician, such as a stroke neurologist, or highly trained specialized medical team can be notified when the patient's condition and acuity level warrant specialized medical treatment. In some embodiments, the patient's acuity level, information about the patient's ailment and condition, and the patient's vital signs are encrypted and securely transferred to the nearest ambulance and the hospital or the specialized medical treatment center (and, more specifically, to the specialized physician and/or medical team at the specialized medical treatment center). In some embodiments, the patient may be accessed by the specialized physician or medical team via video camera or telephone, mobile device, computer monitor, or aid station. Additionally, emergency personnel (such as ambulance drivers and others) would be provided access to the GPS location coordinates of the patient, if available.

As described above by reference to FIG. 1, when the patient's acuity level represents a medical emergency, nearby ambulances are identified, and the nearest ambulance is notified of the patient's condition and acuity level. However, in many cases, merely determining that the patient is suffering from a present medical emergency is not sufficient. In addition, it must be determined whether an ordinary ambulance or a specialized ambulance should be deployed. Specifically, a variety of highly specialized ambulances exist which are outfitted with a variety of highly specialized medical equipment to treat specific types of conditions and include specialized medical professionals suitable for treating such conditions. For example, when a patient suffers a stroke, the time it takes to treat the patient is of the highest importance because every minute the patient is not treated results in greater brain damage. Some ambulances, therefore, are specialized to treat stroke patients, and may include such specialized equipment as on-board imaging devices (e.g., CT head scanner), telemedicine equipment (e.g., to communicate with a neurologist while en route to the ER), and/or lifesaving drugs (e.g., tissue plasminogen activator drugs), and may be staffed by, for example, a critical care nurse, a radiologist and/or CT operator, a paramedic, etc. It would be highly inefficient and expensive to deploy such a specialized stroke ambulance to the location of a patient who has suffered a broken arm, yet failing to deploy the specialized stroke ambulance to the location of a patient suffering a stroke may mean the difference between life and death.

Therefore, the method 200 of some embodiments assists the trained operator to decide whether an ordinary or specialized ambulance is needed for a patient suffering from a present emergency medical condition. In some embodiments, the method 200 obtains (at 160) ambulance service data and information. In some embodiments, the ambulance service data and information includes one or more of the GPS location coordinates of each identified nearby ambulance and the medical capabilities of each nearby ambulance. For example, some ambulances may be suitable for basic life support (BLS) and/or advance life support (ALS), while some other ambulances may be suitable when hazardous materials or waste (HAZMAT) is involved in a patient ailment, and still others may be most suited for stroke cases, or other critical transport. This information about the identified nearby ambulances is used by the decision making process of the method 200 for matching (at 160) the medical patient with the closest available resource that is capable of treating the patient's medical problem. Similarly, the method 200 securely transmits the patient's encrypted acuity level, vital sign data, and medical condition to the closest available resource (e.g., ambulance), which is decrypted upon reception at the closest available resource for evaluation by on-board medical staff.

Beyond identifying and deploying an appropriate emergency vehicle to a patient suffering from a medical emergency, the method 200 further identifies and ranks (at 170) hospitals and/or medical treatment centers in a specified area according to capabilities and present medical center scores. The specified area could be as small as a neighborhood in a community or could be as large as the entire world, depending on the medical needs of the patient (e.g., emergency heart transplants may only be possible at hospitals several hundred miles or more away from the patient).

In some embodiments, medical center scores associated with the patient's medical condition are used to identify hospitals and/or medical treatment centers that are able to treat the patient's medical condition at a level of care that meets or exceeds the patient's acuity level. For example, a cardiovascular center of a first hospital may have a score of 8 out of 10 and a stroke center of the same first hospital may have a score of 2 out of 10, but a different second hospital may be a farther from the patient than the first hospital, but it may have a stroke center with a score of 9 out of 10. Even if the second hospital has no cardiovascular center, and despite its greater distance from the patient, the decision making process of the method 200 may rank the second hospital higher than the first hospital for a patient presently suffering from a major stroke when the trained operator is able to deploy a specialized stroke ambulance to the location of the patient. In contrast, a patient suffering from a ruptured abdominal aortic aneurysm may be directed to the first hospital for emergency cardiovascular treatment in the cardiovascular center of the first hospital and subsequent stroke evaluation by a general physician in the stroke center of the first hospital. In this example, medical center scores suggest a numerical value, but as it pertains to embodiments described herein and as a person skilled in the relevant art would appreciate, scores can be non-number valuations, such as levels, reputations, combinations of numerical scores and levels or reputation, etc.

In addition, the method 200 identifies, scores, and ranks (at 180) nearby medical clinics. The decision making process of the method 200 relies again on service data and information about the clinics in the specified region. While the region may be wide, covering an entire country or the whole world, the typical scenario would be in searching for a clinic within the community of the patient, assuming such a clinic can be found to satisfy the patient's medical condition and acuity level. The service data and information collected about the clinics includes any defined medical information for which a clinic can be evaluated. Examples of the service data and information about the clinics includes obstetrics, orthopedics, internal medicine, ENT, pediatric medicine, etc. Further information about the clinics that may be collected includes accepted insurance, patient satisfaction scores, etc. Overall, the service data and information about the clinics is used to rank the clinic choices available to the patient in view of the patient's medical condition and acuity level.

Next, the method 200 receives one or more selections of healthcare resources (at 190) which are capable of satisfying the patient's medical needs and which meet or exceed the level of care needed to treat the medical ailment according to the patient's acuity level. In some embodiments, the method 200 then ends. However, in some other embodiments, the method 200 returns to step 130 of method 100, described above by reference to FIG. 1. There, additional medical resources and/or information can be identified for use with the patient. For example, wellness triggers can be set up, and/or access can be established to a video camera on the patient's mobile phone or on a mobile medical professional's mobile medical computing/communication device.

Thus, by using the methods 100 and 200, a non-physician can direct medical patients to an appropriate level of care and deploy medical resources to treat the level of care needed according to a patient's acuity level in a way that reduces the need for expensive ER visits or hospital admissions, and other incorrect or inefficient uses of medical resources in the aid of patients.

### III. Decision Making Medical System

Existing healthcare system resource capabilities are typically organized on media (i.e., hard copy paper information or electronic information) and values are assigned as to reference the ability that a particular resource (doctor, clinic, ambulance hospital) has in order to effectively handle a particular medical problem or condition. However, mere organization often leaves a huge gap in the ability of non-physicians to identify and assign a particular resource in the aid of a patient with a particular medical condition. Embodiments of the decision making medical system described in this specification solve this issue by ensuring that an acuity level of a patient with an ailment or medical condition is accurately determined and then appropriately matched to one or more of the healthcare system resources after resource capabilities are defined, weighted, and organized (on such media).

In some embodiments, the decision making medical system includes one or more medical data information systems and associated medical databases, medical computing devices, and software applications that provide access to the medical data information systems and associated medical databases and that visually output an interface for patient information on a computer monitor of a computing device used by a trained operator or on a mobile device screen of a mobile device used by a trained medical professional in a remote location, a field location, or a mobile location. In some embodiments, the medical database associated with the medical data information systems stores medical resource information that identifies medical resources, locations of the medical resources, and availability of the medical resources. In some embodiments, the medical resources include at least an ambulance, a specialized emergency vehicle, a clinic, a hospital, an ER, an urgent care center, and an insurance company. In some embodiments, the medical resource information includes assigned capability scores associated with the level of healthcare that a healthcare resource is capable of providing. In some embodiments, the medical resource information includes identities of medical professionals and weighted scores associated with the level of healthcare that a medical professional is capable of providing. In some embodiments, the medical resource information includes status qualifiers. The status qualifiers include a primary resource qualifier, a secondary resource qualifier, and a tertiary resource qualifier.

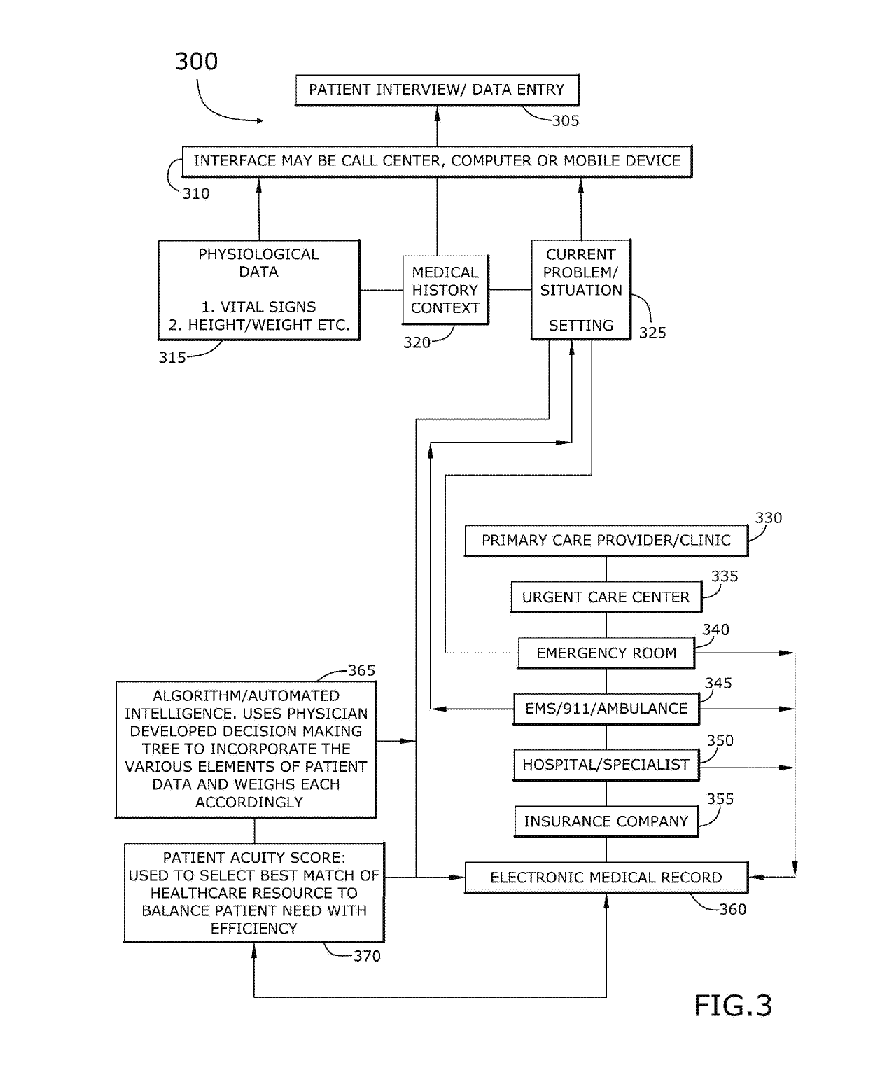

By way of example, FIG. 3 conceptually illustrates a schematic view of a decision making medical system 300 that directs medical patients to appropriate levels of healthcare. As shown in this figure, the decision making medical system 300 includes an interface for patient information 310 that is utilized at the time of patient intake to gather information from several sets of medical information about the patient's condition and to measure acuity level of the patient. At least one set of medical information includes a patient interview 305 conducted by a trained operator at a call center or by another medical professional who enters information about the patient in response to a series of questions designed to accurately identify an acuity level of the patient. Data entry may follow when the patient interview 305 is conducted without a computing device available for data entry. Alternatively, data entry may occur contemporaneously with the series of questions. Another set of medical information about the patient's condition includes physiological data 315 of the patient. The physiological data 315 includes physical information about the patient, such as height and weight, as well as information about vital signs of the patient. Another set of medical information about the patient's condition includes a medical history context 320 associated with the patient. Another set of medical information about the patient's condition includes a current problem/situation setting 325.

In some embodiments of the decision making medical system 300, several of the sets of medical information are retrieved or received from one or more sources in a plurality of sources of medical information about the patient. In some embodiments, the plurality of sources of medical information includes primary care provider/clinic 330, urgent care center 335, emergency room 340, emergency medical service (EMS)/emergency phone line (911)/ambulance 345, hospital/specialist 350, insurance company 355, and electronic medical record 360.

The decision making medical system 300 further includes an algorithm/automated intelligence 365 which uses a physician-developed decision making tree to incorporate the various sets of medical information about the patient and weighs each set of medical information accordingly. The decision making medical system 300 also includes a patient acuity level 370 that is determined based on a variety of factors related to the sets of medical information about the patient and is used to select a best match of a healthcare resource to balance patient need with efficiency.

By way of example, and in reference to the decision making medical system 300, a patient's general condition or ailment may be divulged by the patient to a trained operator during a patient intake interview 305. The trained operator may input the information from the patient interview via the interface for patient information 310. In some embodiments, the interface for patient information 310 is available from an emergency telephone service (e.g., a 911 call station) or a nursing call line. The data entry into the interface for patient information 310 may be entered into a patient intake computing device that is part of the healthcare system. The patient intake computing device may be physically present at a call center, and may be a traditional (non-mobile) computing device, such as a desktop computer, or a mobile computing device, such as a tablet computing device or a laptop computer. Alternatively, a field-based medical professional may enter the patient information into the interface for patient information 310 by using a mobile device (e.g., smartphone, tablet, custom medical mobile device, etc.) from a location that is remote from the call center. For example, an emergency medical technician (EMT) may be a first responder at the scene of a car accident and may use a mobile device to enter patient information into the interface for patient information 310 for each person injured in the car accident.

In some embodiments, each of a series of standardized questions is asked of the patient at the time of the patient intake interview 305, and the information provided by the patient is entered into the computing device via the interface for patient information 310. Next, the patient information is associated with weighted scores 365 (depending on the question being asked) and an acuity level 370 is then calculated for the patient based on the weighted scores 365. In some embodiments, the acuity level 370 is combined with an acuity level based on vital signs and other physiological information 315 about the patient. A medical history context 320 of the patient, if available, can be used to augment the acuity level 370. The final acuity level of the patient is based on the combined acuity levels derived from the patient information and the vital signs information (with or without additional physiological information about the patient or medical history context information about the patient).

In some embodiments, patient acuity level 370 is then matched to the available healthcare system resources to find the best fit and to make sure that a resource assignment is capable of adequately meeting the patient's needs. The patient acuity level 370 also ensures that the decision making medical system 300 does not allocate a medical resource that exceeds a patient's needs if a resource is available that can meet the need. This is done to make sure that the resources with the highest acuity capabilities are kept available for the patients with the highest acuity levels, thereby increasing patient safety and availability of resources for the entire community being served.

If a patient has a condition (e.g., chest pain) the trained operator will look for resources with that capability (e.g., ER vs. doctor's office). If all resources with the capability for chest pain are occupied, then the operator will pick from the resources that have secondary capability to treat chest pain and so forth (i.e., if the level 1 medical center is on divert, the level 2 in closest proximity will be matched).

In some embodiments, the method for directing medical patients to an appropriate level of care is implemented in computer readable code, as a computer program or software application. In some embodiments, checklist and data can be incorporated into a computer checklist and data entered can be processed by a computing device running the computer program or software application using the proprietary sorting and assigning logic. In some embodiments, the computer program or software application runs on a mobile computing device, such as a smartphone or other mobile device with at least one processor. As such, the method for directing medical patients to an appropriate level of care may be done for mobile devices, calculators, or telephones.

In some embodiments, the computer program or software application that implements the method for directing medical patients to an appropriate level of care includes a graphical user interface (GUI) which provides a question/answer visual output format where the patient or operator could enter their variable patient specific data depending on the questions asked. Furthermore, the patient or operator could also enter their vital signs, or use vital sign gathering devices to automatically import that information into the algorithm/logic. In some embodiments, the data could then be used to determine severity and assign a severity of illness to the patient. In some embodiments, data is gathered in real time from the Internet to determine the most appropriate treatment environment for the patient, be it the clinic, urgent care, ER or hospital. In some embodiments, data such as the cost of the services and a facility's acceptance of their insurance is provided to the patient. In some embodiments, data could also be used to allow for video consultation between patient and physician or patient and nurse, depending on the acuity level of the assignment.

### IV. Process for Directing a Medical Patient to an Appropriate Healthcare Resource and Related Processes

In some embodiments, directing medical patients to an appropriate level of care distinguishes between acute medical issues and chronic medical conditions. In some embodiments, directing medical patients to an appropriate level of care involves identifying one or more healthcare resources that are available to treat an acute medical issue of a patient and are suitable to treat the acute medical issue of a determined patient acuity.

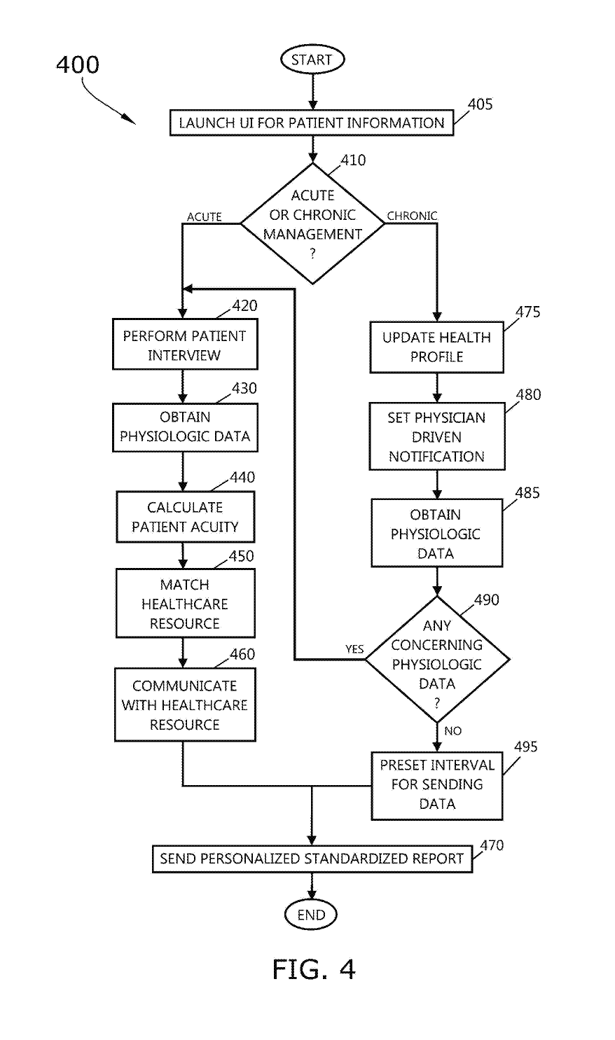

FIG. 4 conceptually illustrates a process for directing a medical patient to an appropriate healthcare resource 400. In some embodiments, the process for directing a medical patient to an appropriate healthcare resource 400 is implemented as a patient healthcare resource matching program with a user interface (UI) for patient information and program modules that determine patient acuity and identify one or more healthcare resources capable of and available to address medical issues of the patient. The patient healthcare resource matching program runs on a processor of a computing device, such as a conventional computer, a server computer, a mobile computing device such as a tablet computing device or a smartphone computing device, or a customized kiosk computing device for patient and non-patient interaction. In some implementations, the UI is displayed on a computing device that connects over a network to a server computer which runs the healthcare resource matching program.

In some embodiments, the process for directing a medical patient to an appropriate healthcare resource 400 starts when the UI for patient information is launched (at 405). Next, the process for directing a medical patient to an appropriate healthcare resource 400 determines (at 410) whether the patient needs acute medical attention and care or needs medical attention and care in relation to management of a chronic medical condition. When the patient needs acute medical attention and care, the process for directing a medical patient to an appropriate healthcare resource 400 transitions to a set of steps for addressing acute medical issues of the patient, which is further described below. Alternatively, when the patient needs medical attention and care in relation to management of a chronic medical condition, the process for directing a medical patient to an appropriate healthcare resource 400 includes updating (at 475) a health profile of the patient, setting (at 480) a physician driven notification, obtaining (at 485) physiologic data of the patient, and determining (at 490) whether there is any concerning physiologic data that may need immediate or follow-up medical attention and care.

When the process for directing a medical patient to an appropriate healthcare resource 400 determines (at 490) that there is no concerning physiologic data, then the process for directing a medical patient to an appropriate healthcare resource 400 presets (at 495) an interval for sending data and sends (at 470) a personalized standardized report to a healthcare resource. When the process for directing a medical patient to an appropriate healthcare resource 400 determines (at 490) that there is concerning physiologic data that may need immediate or follow-up medical attention and care, the process 400 transitions to several steps for gathering additional patient information and determining patient acuity in relation to the concerning physiologic data (or any other medical issue detected while gathering additional patient information). The several steps for gathering additional patient information and determining patient acuity are described below in relation to when the process for directing a medical patient to an appropriate healthcare resource 400 determines (at 410) that the patient needs acute medical attention.

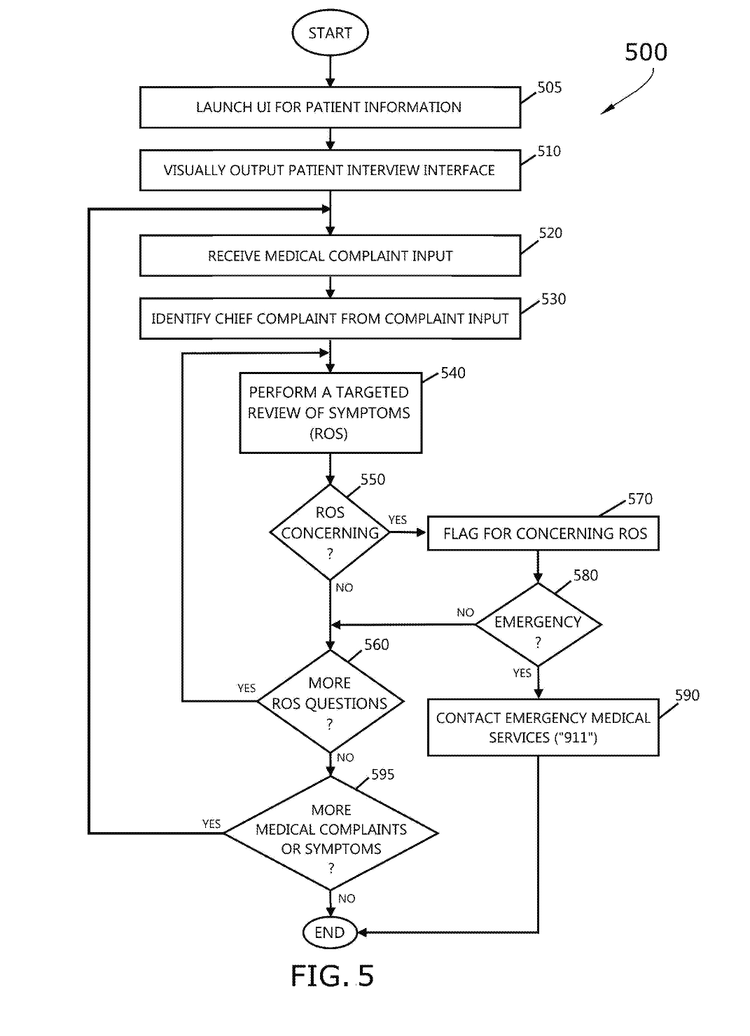

Considering the determination of whether the patient is in need of acute care or management of a chronic condition, when the process for directing a medical patient to an appropriate healthcare resource 400 determines (at 410) that the patient needs acute medical attention and care, then the process 400 starts by performing a patient interview (at 420). Details regarding patient interviews are described in detail by reference to FIGS. 1-3, above, and are described in further detail by reference to FIG. 5, below.

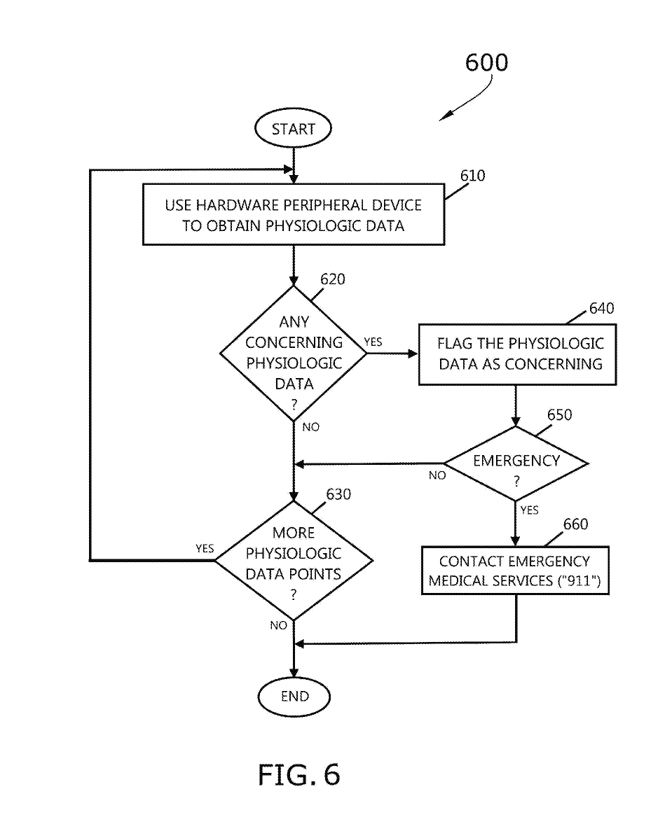

After the patient interview, the process for directing a medical patient to an appropriate healthcare resource 400 of some embodiments obtains (at 430) physiologic data of the patient. Obtaining physiologic data of the patient is described by reference to FIGS. 1-3, above, and is further described by reference to FIG. 6, below.

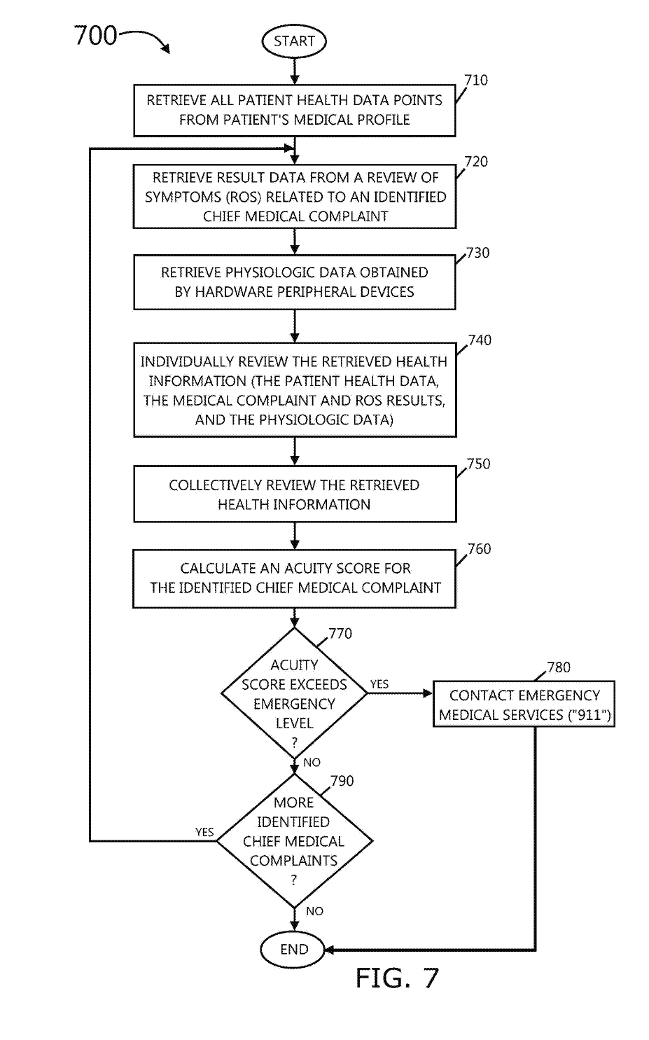

With both the patient information derived from the patient interview and the physiologic data of the patient, the process for directing a medical patient to an appropriate healthcare resource 400 then calculates (at 440) patient acuity. Examples of calculating patient acuity are provided above by reference to FIGS. 1-3, above, and further description is provided by reference to FIG. 7, below.

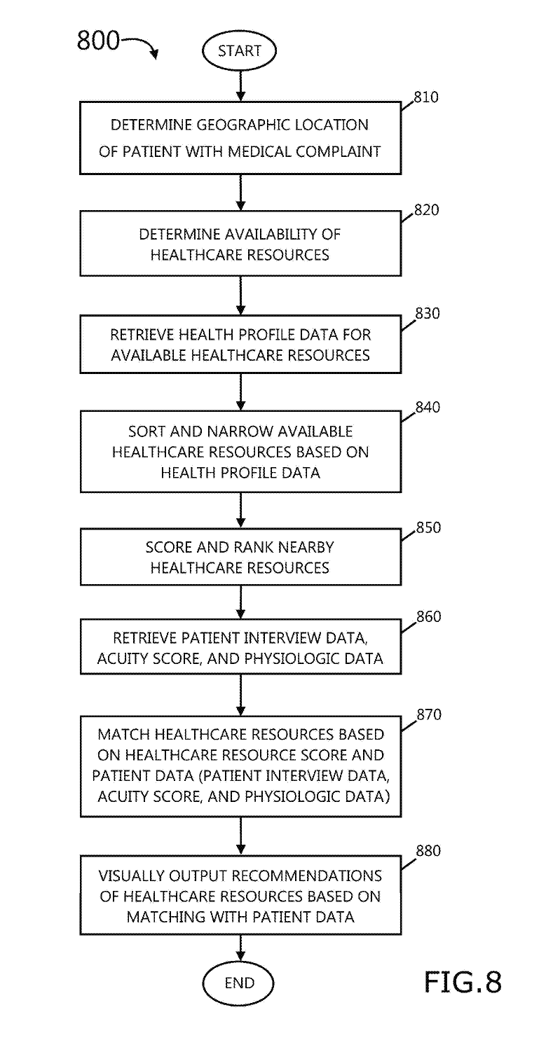

Next, the process for directing a medical patient to an appropriate healthcare resource 400 of some embodiments matches (at 450) a healthcare resource, considering the patient's medical issue (derived from the patient interview) and severity of the medical issue (patient acuity). Matching healthcare resources based on the patient's acuity and medical issue is described by reference to FIGS. 1-3, above, and is further described by reference to FIG. 8, below.

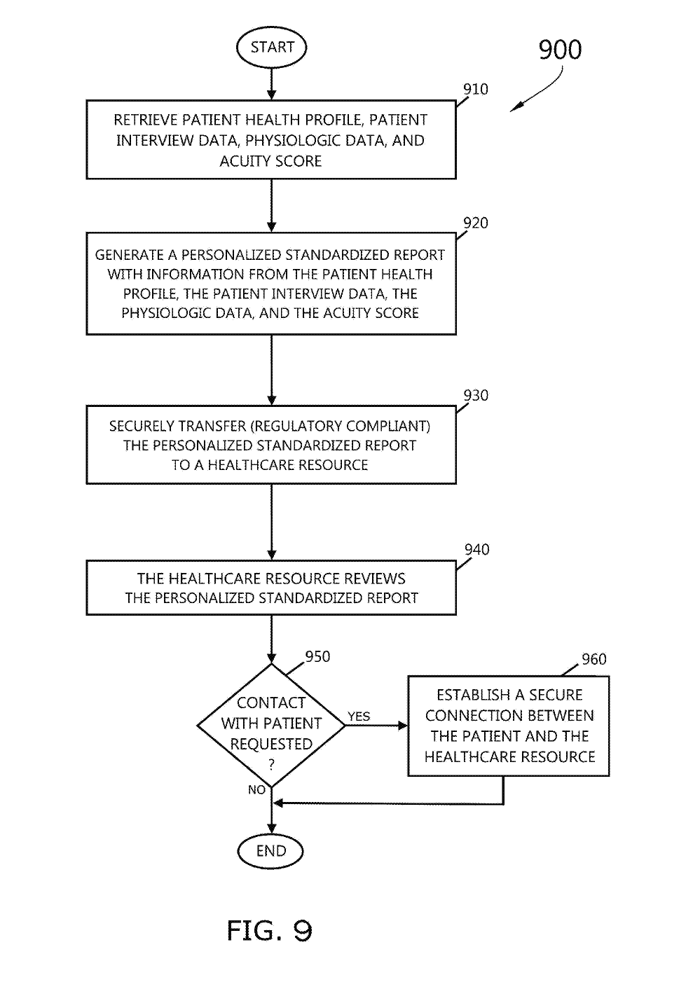

In some embodiments, the process for directing a medical patient to an appropriate healthcare resource 400 communicates (at 460) with the healthcare resource about the patient. Healthcare resource communication is described above by reference to FIGS. 1-3, and is further described below by reference to FIG. 9. Next, the process for directing a medical patient to an appropriate healthcare resource 400 of some embodiments sends (at 470) a personalized standardized report to the healthcare resource. Then the process for directing a medical patient to an appropriate healthcare resource 400 ends.

FIG. 5 conceptually illustrates a patient interview process 500. In some embodiments, the patient interview process 500 is performed in relation to the step for performing a patient interview 420 of the process for directing a medical patient to an appropriate healthcare resource 400, described above by reference to FIG. 4. The patient interview process 500 starts by launching (at 505) the UI for patient information. Next, the patient interview process 500 visually outputs (at 510) a patient interview interface. The patient interview interface walks the patient or another operator through a series of patient interview questions and gathers patient medical information (patient data) to be used in determining patient acuity.

In some embodiments, the patient interview process 500 receives (at 520) medical complaint input. The medical complaint input includes patient-perceived or operator-observed information about a medical issue of the patient. Next, the patient interview process 500 of some embodiments identifies (at 530) a chief medical complaint from the received medical complaint input. Upon identifying the chief medical complaint, the patient interview process 500 of some embodiments performs (at 540) a targeted review of symptoms (“ROS”).

In some embodiments, the patient interview process 500 determines (at 550) whether the ROS includes any concerning symptoms. When the patient interview process 500 determines (at 550) that the ROS does not include any concerning symptoms, then the patient interview process 500 determines (at 560) whether there are more targeted review of symptoms questions remaining. When there are more ROS questions remaining, the patient interview process 500 of some embodiments transitions back to step 540 to perform the targeted review of symptoms, as is described above. When there are no more ROS questions remaining, the patient interview process 500 of some embodiments determines (at 595) whether there are more medical complaints or symptoms of the patient. When the patient interview process 500 affirmatively determines (at 595) that there are more medical complaints or symptoms of the patient, then the patient interview process 500 transitions back to step 520 to receive more medical complaint input. When the patient interview process 500 negatively determines (at 595) that there are no more medical complaints or symptoms of the patient, then the patient interview process 500 ends.

Concerning the determination of whether the ROS includes any concerning symptoms, when the patient interview process 500 affirmatively determines (at 550) that the ROS does include one or more concerning symptoms, then the patient interview process 500 flags (at 570) the concerning symptom. Then the patient interview process 500 of some embodiments determines (at 580) whether the flagged symptom constitutes an emergency medical symptom in which the patient may need immediate emergency medical services. When the patient interview process 500 negatively determines (at 580) that the flagged symptom does not constitute an emergency, then the patient interview process 500 determines (at 560) whether there are more ROS questions remaining. Determining whether there are more ROS questions remaining is described in detail above. When the patient interview process 500 affirmatively determines (at 580) that the flagged symptom constitutes an emergency, then the patient interview process 500 contacts (at 590) emergency medical services (e.g., calling “911”). After emergency medical services are contacted, there are no additional needs to evaluate (at that time) in regard to the patient's medical issues. Therefore, the patient interview process 500 ends after emergency medical services are contacted.

FIG. 6 conceptually illustrates a process for obtaining physiologic data 600 of a patient. In some embodiments, the process for obtaining physiologic data 600 is performed in relation to the step for obtaining physiologic data 430 of the process for directing a medical patient to an appropriate healthcare resource 400, described above by reference to FIG. 4. As shown in this figure, the process for obtaining physiologic data 600 starts with usage of a hardware peripheral device. For example, a thermometer may be used to obtain the temperature of the patient. Therefore, by using the hardware peripheral device, the process for obtaining physiologic data 600 obtains (as 610) physiologic data. While one hardware peripheral device may provide physiologic data for a single physiologic data point, a person skilled in the relevant art understands that some hardware peripheral devices are capable of measuring multiple physiologic data points, thereby allowing the process for obtaining physiologic data 600 to obtain physiologic data for the multiple physiologic data points in a single physiologic data package “transaction” that includes a plurality of physiologic data measurements for a plurality of physiologic data points. Furthermore, when the hardware peripheral device used to obtain the physiologic data is capable of measuring only a single physiologic data point, a person skilled in the art will appreciate that the steps for obtaining the physiologic data can be repeated in relation to the use of multiple different hardware peripheral devices that each obtain only a single measure for a single physiologic data point or a plurality of measurements for a plurality of physiologic data points.

In some embodiments, the process for obtaining physiologic data 600 determines (at 620) whether any of the physiologic data is concerning. For example, a temperature of 108° Fahrenheit (F) may be considered dangerously concerning, while a temperature of 99.6° F. may be considered high, but not concerning.

When the process for obtaining physiologic data 600 negatively determines (at 620) that there is no concerning physiologic data, then the process 600 determines (at 630) whether there are any more physiologic data points to obtain and evaluate. When the process for obtaining physiologic data 600 affirmatively determines (at 630) that there are more physiologic data points to obtain and evaluate, then the process for obtaining physiologic data 600 returns to step 610 to obtain the physiologic data by way of an appropriate hardware peripheral device. On the other hand, when the process for obtaining physiologic data 600 negatively determines (at 630) that there are no more physiologic data points to obtain and evaluate, then the process for obtaining physiologic data 600 ends.

Turning back to the determination of whether any of the physiologic data is concerning, when the process for obtaining physiologic data 600 affirmatively determines (at 620) that there is concerning physiologic data, then the process 600 flags (at 640) the physiologic data as concerning. Next, the process for obtaining physiologic data 600 determines (at 650) whether the flagged physiologic data is concerning enough to be an emergency. When the process for obtaining physiologic data 600 negatively determines (at 650) that the flagged physiologic data does not constitute an emergency, then the process 600 transitions to step 630 to determine whether there are more physiologic data points to obtain and evaluate, as is described above. On the other hand, when the process for obtaining physiologic data 600 affirmatively determines (at 650) that the flagged physiologic data constitutes an emergency, then the process 600 contacts (at 660) emergency medical services (e.g., calling “911”). Then the process for obtaining physiologic data 600 ends.

FIG. 7 conceptually illustrates a process for calculating patient acuity 700. In some embodiments, the process for calculating patient acuity 700 is performed in relation to the step for calculating patient acuity 440 of the process for directing a medical patient to an appropriate healthcare resource 400, described above by reference to FIG. 4. As shown in this figure, the process for calculating patient acuity 700 starts by retrieving (at 710) all patient health data points from the patient's medical profile. Next, the process for calculating patient acuity 700 retrieves (at 720) result data from a targeted review of symptoms (ROS) related to an identified chief medical complaint. In some embodiments, the process for calculating patient acuity 700 repeats the steps starting 720 for each chief medical complaint identified for the patient. After the ROS data is retrieved for the identified chief medical complaint, the process for calculating patient acuity 700 retrieves (at 730) physiologic data obtained by one or more hardware peripheral devices.

After the health information of the patient (e.g., the patient health data, the medical complaint and ROS result data, and the physiologic data) is retrieved, the process for calculating patient acuity 700 of some embodiments individually reviews (at 740) the retrieved health information. In some embodiments, the process for calculating patient acuity 700 then collectively reviews (at 750) the retrieved health information of the patient. In this way, the process for calculating patient acuity 700 of some embodiments performs a two-pass review of the retrieved information of the patient, individual review and collective review.

In some embodiments, the process for calculating patient acuity 700 calculates (at 760) an acuity score for the identified chief medical complaint. In some embodiments, the process for calculating patient acuity 700 determines (at 770) whether the acuity score exceeds a threshold emergency level. When the process for calculating patient acuity 700 negatively determines (at 770) that the acuity score does not exceed the threshold emergency level, then the process for calculating patient acuity 700 determines (at 790) whether there are more identified chief medical complaints to process. When the process for calculating patient acuity 700 affirmatively determines (at 790) that there are more identified chief medical complaints to process, then the process for calculating patient acuity 700 returns to step 720 to repeat the aforementioned steps of the process 700. When the process for calculating patient acuity 700 negatively determines (at 790) that there are no more identified chief medical complaints to process, then the process for calculating patient acuity 700 ends.

Concerning the determination of whether the acuity score exceeds a threshold emergency level, when the process for calculating patient acuity 700 affirmatively determines (at 770) that the acuity score exceeds the threshold emergency level, then the process for calculating patient acuity 700 contacts (at 780) emergency medical services (e.g., calling “911”). Then the process for calculating patient acuity 700 ends.

FIG. 8 conceptually illustrates a process for matching and recommending healthcare resources 800 for a patient. In some embodiments, the process for matching and recommending healthcare resources 800 is performed in relation to the step for matching a healthcare resource 450 of the process for directing a medical patient to an appropriate healthcare resource 400, described above by reference to FIG. 4. As shown in this figure, the process for matching and recommending healthcare resources 800 for the patient begins by determining (at 810) a geographic location of the patient with the medical complaint. The geographical location can be determined by any of several well-known mechanisms, such as by direct patient input of a geographical location identifier (e.g., address, zip code, city, medical facility, etc.). In some embodiments, the process for matching and recommending healthcare resources 800 then determines (at 820) availability of healthcare resources. In some embodiments, the process for matching and recommending healthcare resources 800 then retrieves (at 830) health profile data for the healthcare resources that are determined to be available.

Next, the process for matching and recommending healthcare resources 800 of some embodiments sorts and narrows (at 840) the available healthcare resources based on their respective health profile data. In some embodiments, the process for matching and recommending healthcare resources 800 then scores and ranks (at 850) nearby healthcare resources based on the geographic location of the patient and results of the sorting and narrowing of the available healthcare resources. In some embodiments, the process for matching and recommending healthcare resources 800 then retrieves (at 860) patient interview data, the acuity score, and the patient's physiologic data obtained via hardware peripheral device(s).

Next, the process for matching and recommending healthcare resources 800 of some embodiments matches (at 870) healthcare resources based on healthcare resource scores and patient data (including the patient interview data, the patient acuity, and the patient's physiologic data). The process for matching and recommending healthcare resources 800 visually outputs (at 880) recommendations of healthcare resources based on the results of matching with the patient data. Then the process for matching and recommending healthcare resources 800 ends.

FIG. 9 conceptually illustrates a process for generating and securely transferring a personalized standardized report regarding the patient to a healthcare resource 900. In some embodiments, the process for generating and securely transferring a personalized standardized report regarding the patient to a healthcare resource 900 is performed in relation to the steps for communicating with the healthcare resource 460 and sending the personalized standardized report 470 of the process for directing a medical patient to an appropriate healthcare resource 400, described above by reference to FIG. 4. As shown in this figure, the process for generating and securely transferring a personalized standardized report regarding the patient to a healthcare resource 900 starts by retrieving (at 910) the patient health profile, the patient interview data, the patient's physiologic data, and the patient acuity score.

In some embodiments, the process for generating and securely transferring a personalized standardized report regarding the patient to a healthcare resource 900 generates (at 920) a personalized, standardized report with information from the patient health profile, the patient interview data, physiologic data of the patient, and the patient acuity score. Next, the process for generating and securely transferring a personalized standardized report regarding the patient to a healthcare resource 900 of some embodiments securely transfers (at 930) the personalized, standardized report to a healthcare resource in a regulatory compliant manner. For example, the transmission of the personalized, standardized report to the healthcare resource may be HIPAA-compliant to ensure patient medical privacy.

When the healthcare resource receives the personalized, standardized report, it may review (at 940) the report and decide whether or not to request contact with the patient. In some embodiments, the process for generating and securely transferring a personalized standardized report regarding the patient to a healthcare resource 900 determines (at 950) whether the healthcare resource has requested contact with the patient. When the healthcare resource has not requested to contact the patient, then the process for generating and securely transferring a personalized standardized report regarding the patient to a healthcare resource 900 ends. When the process for generating and securely transferring a personalized standardized report regarding the patient to a healthcare resource 900 affirmatively determines (at 950) that the healthcare resource has requested contact with the patient, then the process 900 establishes (at 960) a secure connection between the patient and the healthcare resource. The secure connection satisfies regulatory compliance schemes, as noted above (e.g., HIPAA-compliant). Then the process for generating and securely transferring a personalized standardized report regarding the patient to a healthcare resource 900 ends.

### V. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic, electronic, or optical storage, which can be read into memory for processing by a processor. Also, in some embodiments, multiple software inventions can be implemented as sub-parts of a larger program while remaining distinct software inventions. In some embodiments, multiple software inventions can also be implemented as separate, possibly interacting, programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

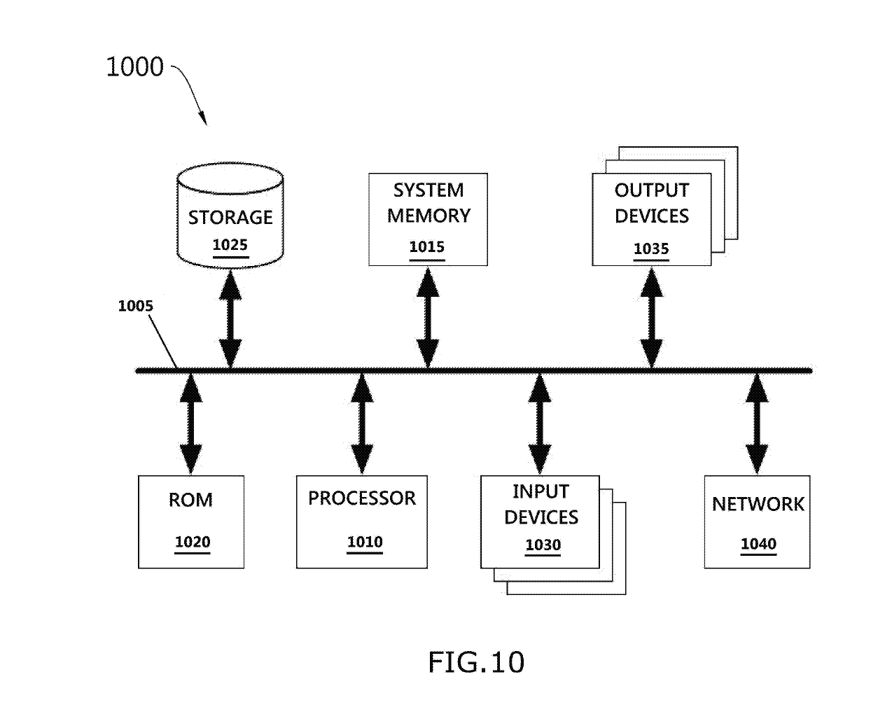

FIG. 10 conceptually illustrates an electronic system 1000 with which some embodiments of the invention are implemented. The electronic system 1000 may be a computer, phone, PDA, or any other sort of electronic device. Such an electronic system includes various types of computer readable media and interfaces for various other types of computer readable media. Electronic system 1000 includes a bus 1005, processing unit(s) 1010, a system memory 1015, a read-only 1020, a permanent storage device 1025, input devices 1030, output devices 1035, and a network 1040.

The bus 1005 collectively represents all system, peripheral, and chipset buses that communicatively connect the numerous internal devices of the electronic system 1000. For example, the bus 1005 communicatively connects the processing unit(s) 1010 with the read-only memory 1020, the system (ephemeral) memory 1015, and the permanent storage device 1025.

From these various memory units, the processing unit(s) 1010 retrieves instructions to execute and data to process in order to execute the processes of the invention. The processing unit(s) may be a single processor or a multi-core processor in different embodiments.

The read-only-memory (ROM) 1020 stores static data and instructions that are needed by the processing unit(s) 1010 and other modules of the electronic system. The permanent storage device 1025 is a read-and-write memory device. This device is a non-volatile memory unit that stores instructions and data even when the electronic system 1000 is off. Some embodiments of the invention use a mass-storage device (such as a magnetic or optical disk and its corresponding disk drive) as the permanent storage device 1025.

Other embodiments use a removable storage device (such as a floppy disk or a flash drive) as the permanent storage device 1025. Like the permanent storage device 1025, the system memory 1015 is a read-and-write memory device. However, unlike storage device 1025, the system memory 1015 is a volatile read-and-write memory, such as a random access memory. The system memory 1015 stores some of the instructions and data that the processor needs at runtime. In some embodiments, the invention's processes are stored in the system memory 1015, the permanent storage device 1025, and/or the read-only 1020. For example, the various memory units include instructions for processing appearance alterations of displayable characters in accordance with some embodiments. From these various memory units, the processing unit(s) 1010 retrieves instructions to execute and data to process in order to execute the processes of some embodiments.

The bus 1005 also connects to the input and output devices 1030 and 1035. The input devices enable the user to communicate information and select commands to the electronic system. The input devices 1030 include alphanumeric keyboards and pointing devices (also called “cursor control devices”). The output devices 1035 display images generated by the electronic system 1000. The output devices 1035 include printers and display devices, such as cathode ray tubes (CRT) or liquid crystal displays (LCD). Some embodiments include devices such as a touchscreen that functions as both input and output devices.

Finally, as shown in FIG. 10, bus 1005 also couples electronic system 1000 to a network 1040 through a network adapter (not shown). In this manner, the computer can be a part of a network of computers (such as a local area network (“LAN”), a wide area network (“WAN”), or an intranet), or a network of networks (such as the Internet). Any or all components of electronic system 1000 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, FIGS. 1 and 2 conceptually illustrate a method for directing medical patients to an appropriate level of healthcare, FIG. 4 conceptually illustrates a process for directing a medical patient to an appropriate healthcare resource, and FIGS. 5-9 conceptually illustrate processes of several of the steps in the process for directing a medical patient to an appropriate healthcare resource. The specific operations of the method and processes may not be performed in the exact order shown and described. Specific operations may not be performed in one continuous series of operations, and different specific operations may be performed in different embodiments. Furthermore, the method and processes could be implemented using several sub-routine methods and processes, or as part of a larger macro method or process. Thus, one of ordinary skill in the art would understand that the invention is not to be limited by the foregoing illustrative details, but rather is to be defined by the appended claims.

1. A non-transitory computer readable medium storing a program which, when executed by at least one processing unit of a computing device, directs a medical patient to an appropriate level of healthcare, said program comprising sets of instructions for:
launching a graphical user interface (GUI) for patient information;
visually outputting, on a display screen communicably connected to the computing device, a patient interview user interface (UI);
receiving medical complaint information about a medical patient with a present medical issue, wherein the medical complaint information is entered into the patient interview UI;
identifying a chief medical issue from the received medical complaint information;
setting an acuity level based on the chief medical issue and the medical complaint information;
performing a targeted review of symptoms (ROS);
retrieving physiological data of the medical patient during the targeted ROS;
setting a physiological data acuity level based on the retrieved physiological data;
calculating an overall patient medical issue acuity level based on a combination of the acuity level and the physiological data acuity level;
determining whether the overall patient medical issue acuity level represents a medical emergency;
contacting emergency medical services when the overall patient medical issue acuity level represents a medical emergency;
determining a geographic location of the medical patient;
retrieving medical resource information from a medical database associated with a medical data information system, wherein the medical resource information retrieved from the medical database includes information that identifies healthcare resources that are available and health profile data for each identified healthcare resource;
sorting the identified healthcare resources based on the health profile data of each identified healthcare resource in view of the medical issue of the medical patient;
scoring the sorted healthcare resources in view of the overall patient medical issue acuity level and the geographic location of the medical patient; and
identifying a healthcare resource capable of treating the medical issue of the medical patient at a level that substantially matches the overall patient medical issue acuity level based on the healthcare resource scores when the overall patient medical issue acuity level does not represent a medical emergency.

2. (canceled)

3. The non-transitory computer readable medium of claim 1, wherein the physiological data of the patient comprises a set of vital signs data and a set of physical patient health data.

4. The non-transitory computer readable medium of claim 3, wherein the program further comprises a set of instructions for receiving the vital signs data from a physician treating the patient.

5. (canceled)

6. The non-transitory computer readable medium of claim 1, wherein the program further comprises a set of instructions for obtaining ambulance service data.

7. The non-transitory computer readable medium of claim 6, wherein the ambulance service data includes information about nearby ambulances capable of providing emergency medical transportation, said information comprising at least one of a location of a nearby ambulance, a capability of the nearby ambulance, and a type of ambulance service.

8. The non-transitory computer readable medium of claim 7, wherein the program further comprises a set of instructions for ranking nearby hospitals according to medical capabilities.

9. The non-transitory computer readable medium of claim 7, wherein the program further comprises a set of instructions for ranking nearby medical clinics according to at least one of medical specialties of a clinic, acceptability of insurance at the clinic, and patient satisfaction scores.

10. The non-transitory computer readable medium of claim 7, wherein the set of instructions for identifying a healthcare resource capable of treating the medical issue of the medical patient at a level that substantially matches the overall patient medical issue acuity level based on the healthcare resource scores comprises a set of instructions for choosing the healthcare resource from a set of healthcare resources with a healthcare score for the healthcare resource and a nearby availability that is suitable for a medical emergency and that satisfies the patient's acuity level.

11. The non-transitory computer readable medium of claim 1, wherein the program further comprises a set of instructions for determining whether there are any concerning symptoms in the targeted ROS.

12. The non-transitory computer readable medium of claim 11, wherein the program further comprises a set of instructions for flagging the targeted ROS of the medical patient as concerning when there is at least one concerning symptom.

13. The non-transitory computer readable medium of claim 12, wherein the program further comprises sets of instructions for:
determining whether the flagged ROS of the medical patient represents a medical emergency; and
contacting emergency medical services when the flagged ROS of the medical
